(19) United States
(12) Patent Application Publication
(10) Pub. No.: US 2012/0319931 A1
(43) Pub. Date: Dec. 20, 2012

(54) DRIVING CIRCUIT OF A DISPLAY

(75) Inventor: CHEN YU WANG, Tainan City (TW)

(73) Assignee: RAYDIUM SEMICONDUCTOR CORPORATION, HSINCHU (TW)

(21) Appl. No.: 13/523,573

(22) Filed: Jun. 14, 2012

(30) Foreign Application Priority Data
Jun. 15, 2011 (TW) 100120819

(51) Int. Cl. G09G 3/34

(52) U.S. Cl. 345/84

(57) ABSTRACT

The current disclosure discloses a driving circuit of a liquid crystal display. The driving circuit comprises a P-DAC, an N-DAC, a first input amplifier, a second input amplifier, a first output amplifier, a second output amplifier, a first switching circuit, a second switching circuit and a third switching circuit. The driving circuit is able to provide better brightness compensation for a corresponding pixel electrode and reduce the time needed to drive the corresponding pixel electrode.

### BACKGROUND

1. Field of the Invention

The current disclosure relates to a driving circuit of a display and, in particular, to a driving circuit of a display, which is capable of providing better brightness compensation for a corresponding pixel electrode and reducing the time needed to drive the corresponding pixel electrode.

2. Description of the Related Art

Due to rapid developments in technology, liquid crystal display (LCD) is now applied in a wide range of electronic devices such as mobile phones, PCs, laptops, and PDAs. However, since an LCD panel cannot illuminate by itself, therefore, it is necessary to provide a backlight as a displaying light source under the LCD panel. Moreover, the amount of light transmission through an LCD panel is determined by the rotation angle of internal LC molecules.

The rotation angle of internal LC molecules in a pixel is associated with the voltage difference between a pixel electrode and a common electrode of the pixel. Since the voltage of the common electrode is generally a fixed value, the light transmission ratio of the pixel may be determined by controlling the voltage applied to the pixel electrode. A conventional LCD driving circuit may use voltage buffers to stabilize the applied voltage. In ideal situation, a desirable voltage buffer will produce an output voltage with no deviation from an input voltage. In other words, for a desirable voltage buffer, there is no difference between the input voltage and the output voltage.

However, some conventional LCD driving circuits may use different voltage buffers to output voltage for driving pixels. As a result, different voltage deviations may exist between input voltage and output voltage of the voltage buffers, which consequently deteriorate the displaying quality of the LCD.

To address the issue, a driving circuit for a display device is disclosed, which provides better brightness compensation for a corresponding pixel electrode and reduces the time needed to drive the corresponding pixel electrode.

### SUMMARY

In accordance with one embodiment of the present invention, a driving circuit of an LCD display comprises a P-DAC, an N-PAC, a first input amplifier, a second input amplifier, a first output amplifier, a second output amplifier, a first switch circuit, a second switch circuit and a third switch circuit.

The first switch circuit is coupled at one side to the P-DAC and the N-DAC, and at the other side to the first input amplifier and the second amplifier. The second switch circuit is coupled at one side to the first input amplifier and the second amplifier, and at the other side to the first output amplifier and the second output amplifier. The third switch circuit is coupled at one side to the first output amplifier and the second output amplifier, and at the other side to a first pixel electrode and a second pixel electrode.

The first switch circuit comprises a first switch which has a first terminal coupled to the P-DAC and second terminals separately coupled to the first input amplifier and the second input amplifier, and a second switch which has a first terminal coupled to the N-DAC and second terminals separately coupled to the first input amplifier and the second input amplifier.

The second switch circuit comprises a third switch which has a first terminal coupled to the first input amplifier and second terminals separately coupled to the first output amplifier and the second output amplifier, and a fourth switch which has a first terminal coupled to the second input amplifier and second terminals separately coupled to the first output amplifier and the second output amplifier.

The third switch circuit comprises a fifth switch which has a first terminal coupled to the first output amplifier and second terminals separately coupled to the first pixel electrode and the second pixel electrode, and a sixth switch which has a first terminal coupled to the second output amplifier and second terminals separately coupled to the first pixel electrode and the second pixel electrode.

In order to provide further understanding of the techniques, means, and effects of the current disclosure, the following detailed description and drawings are hereby presented, such that the purposes, features and aspects of the current disclosure may be thoroughly and concretely appreciated; however, the drawings are provided solely for reference and illustration, without any intention to be used for limiting the current disclosure.

### BRIEF DESCRIPTION OF THE DRAWINGS

The objectives and advantages of the present invention are illustrated with the following description and upon reference to the accompanying drawings, in which:

FIG. 1 is a schematic view of one embodiment of the present invention showing a driving circuit of an LCD display;

FIG. 2 is a schematic view of one embodiment of the present invention showing a first conducting path during a first frame period of a driving circuit of an LCD display;

FIG. 3 is a schematic view of one embodiment of the present invention showing a second conducting path during a first frame period of a driving circuit of an LCD display;

FIG. 4 is a schematic view of one embodiment of the present invention showing a third conducting path during a second frame period of a driving circuit of an LCD display; and

FIG. 5 is a schematic view of one embodiment of the present invention showing a fourth conducting path during a second frame period of a driving circuit of an LCD display.

### DETAILED DESCRIPTION OF THE INVENTION

In order to solve the problem of a conventional driving circuit of an LCD display, the present invention discloses a driving circuit of an LCD display.

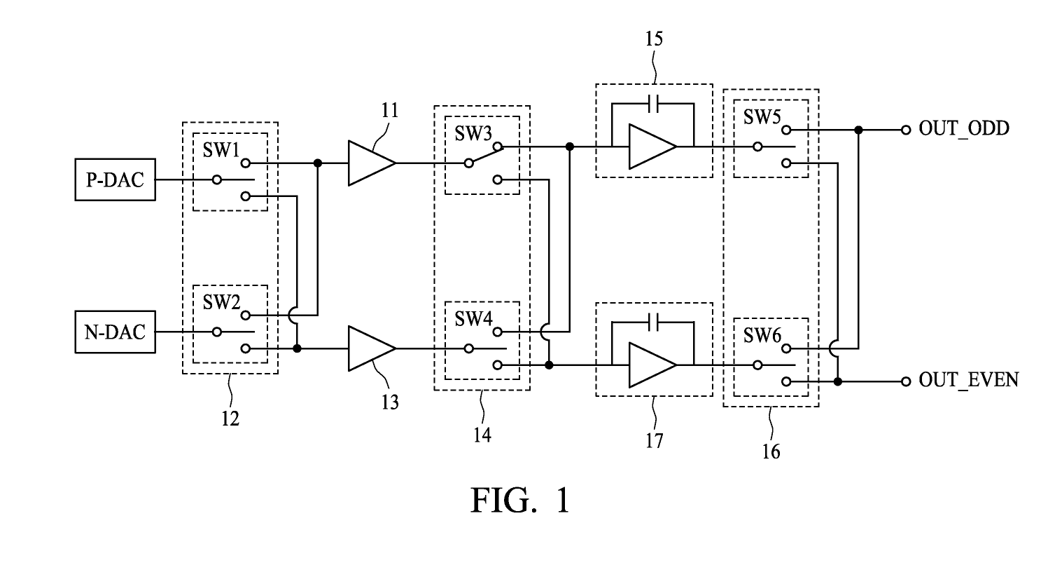

FIG. 1 is a schematic view of one embodiment of the present invention showing a driving circuit of an LCD display. The driving circuit of the LCD display includes a positive digital-to-analog converter (P-DAC), a negative digital-to-analog converter (N-DAC), a first input amplifier 11, a second input amplifier 13, a first output amplifier 15, a second output amplifier 17, a first pixel electrode “OUT_ODD,” a second pixel electrode “OUT_EVEN,” a first switch circuit 12, a second switch circuit 14 and a third switch circuit 16.

The first switch circuit 12 includes a first switch SW1 and a second switch SW2. The first switch SW1 has a first terminal coupled to the P-DAC and second terminals separately coupled to the first input amplifier 11 and the second input amplifier 13. The second switch SW2 has a first terminal coupled to the N-DAC and second terminals separately coupled to the first input amplifier 11 and the second input amplifier 13.

The second switch circuit 14 includes a third switch SW3 and a fourth switch SW4. The third switch SW3 has a first terminal coupled to the first input amplifier 11 and second terminals separately coupled to the first output amplifier 15 and the second output amplifier 17. The fourth switch SW4 has a first terminal coupled to the second input amplifier 13 and second terminals separately coupled to the first output amplifier 15 and the second output amplifier 17.

The third switch circuit 16 includes a fifth switch SW5 and a sixth switch SW6. The fifth switch SW5 has a first terminal coupled to the first output amplifier 15 and second terminals separately coupled to the first pixel electrode OUT_ODD and the second pixel electrode OUT_EVEN. Similarly, the sixth switch SW6 has a first terminal coupled to the second output amplifier 17 and second terminals separately coupled to the first pixel electrode OUT_ODD and the second pixel electrode OUT_EVEN.

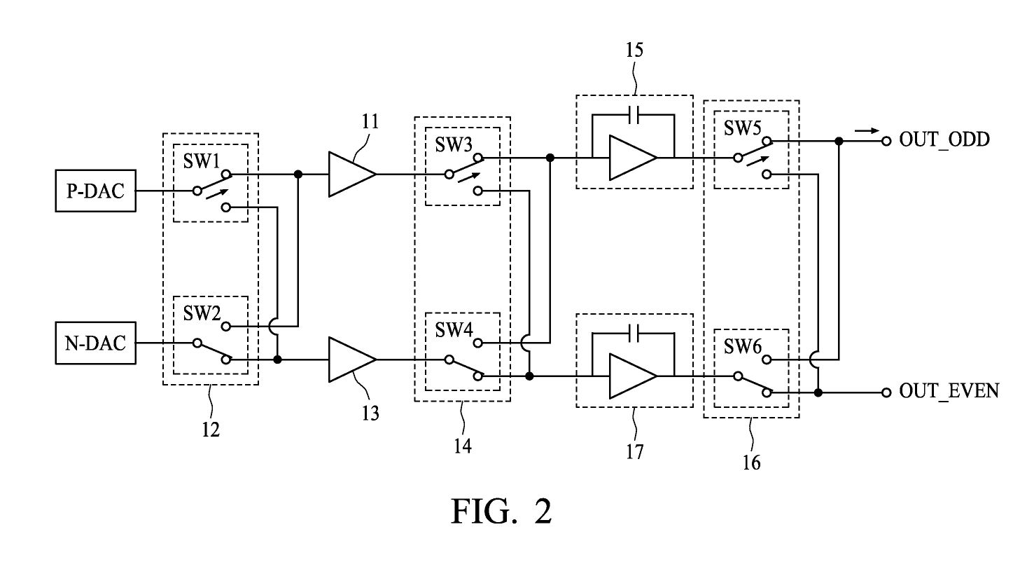

FIG. 2 is a schematic view of one embodiment of the present invention showing a first conducting path during a first frame period of a driving circuit of an LCD display. As shown in FIG. 2, the first switch SW1 connects the P-DAC and the first input amplifier 11, the third switch SW3 connects the first input amplifier 11 and the first output amplifier 15 and the fifth switch SW5 connects the first output amplifier 15 and the first pixel electrode OUT_ODD, thereby forming the first conducting path, via which a positive voltage is output to the first pixel electrode OUT_ODD. Moreover, the first output amplifier 15 may rapidly drive the first pixel electrode OUT_ODD by way of capacitive coupling. Meanwhile, the first output amplifier 15 is at a positive, full-load voltage status.

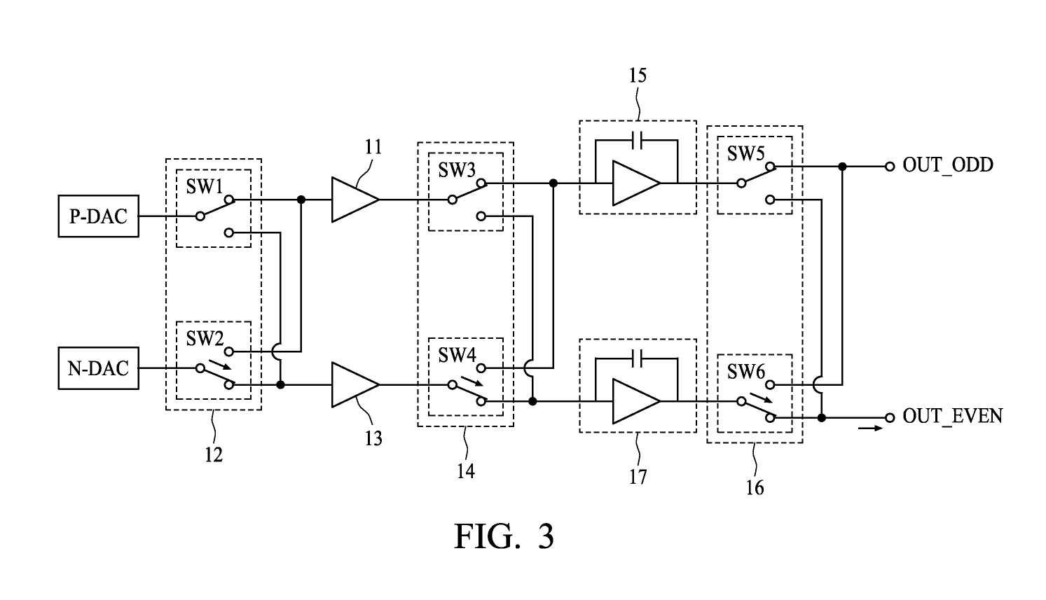

FIG. 3 is a schematic view of one embodiment of the present invention showing a second conducting path during a first frame period of a driving circuit of an LCD display. As shown in FIG. 3, the second switch SW2 connects the N-DAC and the second input amplifier 13, the fourth switch SW4 connects the second input amplifier 13 and the second output amplifier 17 and the sixth switch SW6 connects the second output amplifier 17 and the second pixel electrode OUT_EVEN, thereby forming the second conducting path, via which a negative voltage is output to the second pixel electrode OUT_EVEN. Moreover, the second output amplifier 17 may rapidly drive the second pixel electrode OUT_EVEN by way of capacitive coupling. Meanwhile, the second output amplifier 17 is at a negative, full-load voltage status.

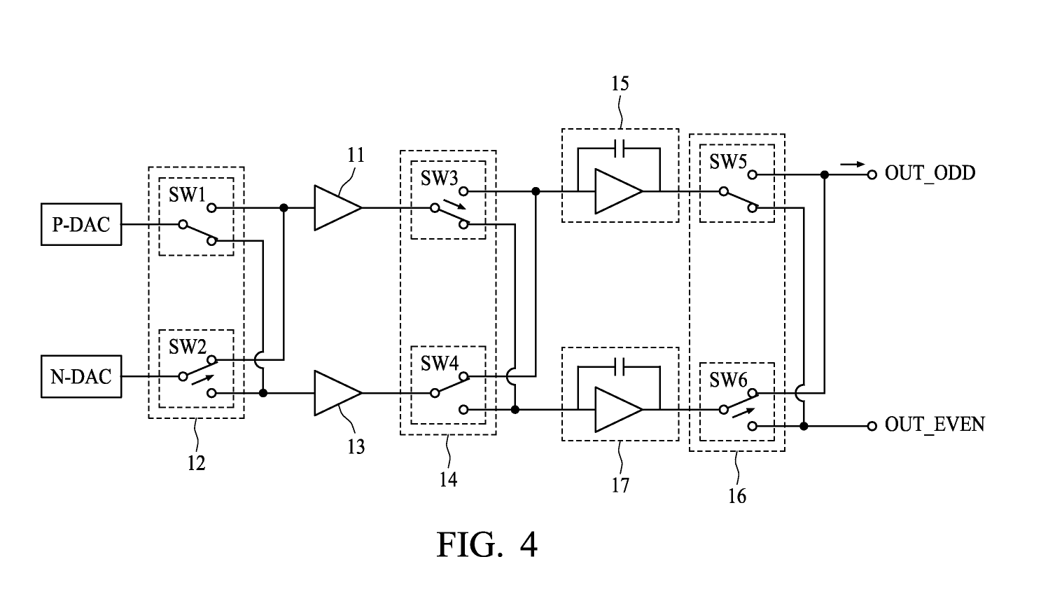

FIG. 4 is a schematic view of one embodiment of the present invention showing a third conducting path during a second frame period of a driving circuit of an LCD display. During the second frame period, the negative voltage is output to the first pixel electrode OUT_ODD and the positive voltage is output to the second pixel electrode OUT_EVEN.

As shown in FIG. 4, the second switch SW2 connects the N-DAC and the first input amplifier 11, the third switch SW3 connects the first input amplifier 11 and the second output amplifier 17 and the sixth switch SW6 connects the second output amplifier 17 and the first pixel electrode

OUT_ODD, thereby forming the third conducting path, via which a negative voltage is output to the first pixel electrode OUT_ODD.

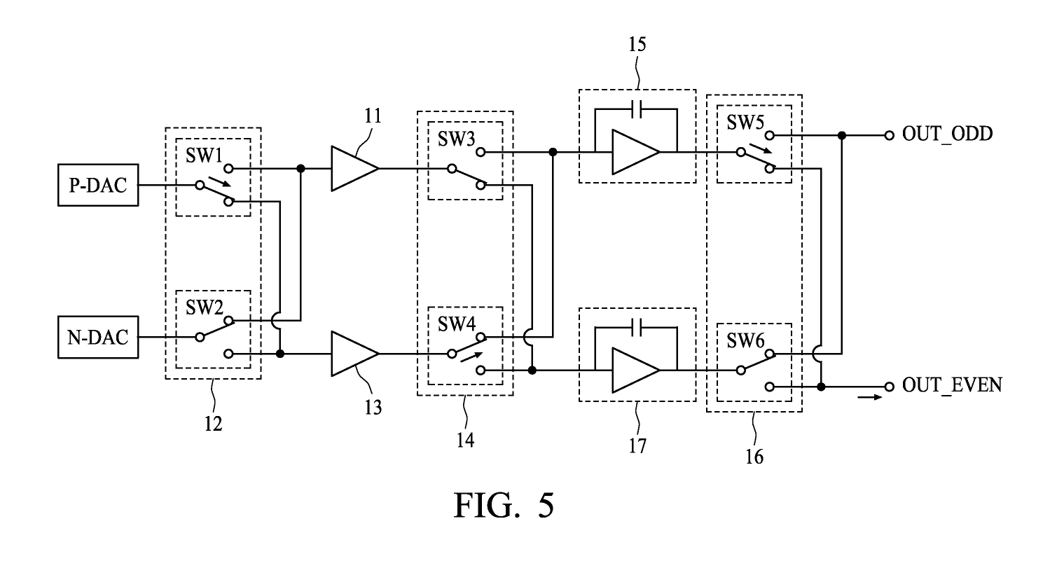

FIG. 5 is a schematic view of one embodiment of the present invention showing a fourth conducting path during a second frame period of a driving circuit of an LCD display. As shown in FIG. 5, the first switch SW1 connects the P-DAC and the second input amplifier 13, the fourth switch SW4 connects the second input amplifier 13 and the first output amplifier 15, the fifth switch connects the first output amplifier 15 and the second pixel electrode OUT_EVEN, thereby forming the fourth conducting path, via which a positive voltage is output to the second pixel electrode OUT_EVEN.

A comparison between the first conducting path and the third conducting path reveals that both the two paths reach the first pixel electrode OUT_ODD and pass through the first input amplifier 11 for reducing voltage deviation at the first pixel electrode OUT_ODD during the second frame period. Meanwhile, during the second frame period, the second output amplifier 17 remains at the negative, full-load voltage status so that the negative voltage may be rapidly output to the first pixel electrode OUT_ODD.

A comparison between the second conducting path and the fourth conducting path reveals that both the two paths reach the first pixel electrode OUT_EVEN and pass through the second input amplifier 13 for reducing voltage deviation at the second pixel electrode OUT_EVEN during the second frame period. Meanwhile, during the second frame period, the first output amplifier 15 remains at the positive, full-load voltage status so that the positive voltage may be rapidly output to the second pixel electrode OUT_EVEN.

Although the present invention and its objectives have been described in detail, it should be understood that various changes, substitutions and alterations can be made herein without departing from the spirit and scope of the invention as defined by the appended claims. For example, many of the processes discussed above can be implemented using different methodologies, replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A driving circuit of a liquid crystal display (LCD), the driving circuit comprising:
a positive digital-to-analog converter (P-DAC);
a negative digital-to-analog converter (N-PAC);
a first input amplifier;
a second input amplifier;
a first output amplifier;
a second output amplifier;
a first switch circuit, which is coupled at one side to the P-DAC and the N-DAC, and at the other side to the first input amplifier and the second amplifier;
a second switch circuit, which is coupled at one side to the first input amplifier and the second amplifier, and at the other side to the first output amplifier and the second output amplifier; and
a third switch circuit, which is coupled at one side to the first output amplifier and the second output amplifier, and at the other side to a first pixel electrode and a second pixel electrode.

2. The driving circuit of an LCD display of claim 1, wherein the first switch circuit comprises a first switch which has a first terminal coupled to the P-DAC and second terminals separately coupled to the first input amplifier and the second input amplifier, and a second switch which has a first terminal coupled to the N-DAC and second terminals separately coupled to the first input amplifier and the second input amplifier.

3. The driving circuit of an LCD display of claim 1, wherein the second switch circuit comprises a third switch which has a first terminal coupled to the first input amplifier and second terminals separately coupled to the first output amplifier and the second output amplifier, and a fourth switch which has a first terminal coupled to the second input amplifier and second terminals separately coupled to the first output amplifier and the second output amplifier.

4. The driving circuit of an LCD display of claim 1, wherein the third switch circuit comprises a fifth switch which has a first terminal coupled to the first output amplifier and second terminals separately coupled to the first pixel electrode and the second pixel electrode, and a sixth switch which has a first terminal coupled to the second output amplifier and second terminals separately coupled to the first pixel electrode and the second pixel electrode.

5. The driving circuit of an LCD display of claim 1, wherein during a first frame period of the LCD display, the first switch circuit connects the P-DAC and the first input amplifier, and connects the N-DAC and the second input amplifier; the second switch circuit connects the first input amplifier and the first output amplifier, and connects the second input amplifier and the second output amplifier, and the third switch circuit connects the first output amplifier and the first pixel electrode, and connects the second output amplifier and the second pixel electrode.

6. The driving circuit of an LCD display of claim 1, wherein during a second frame period of the LCD display, the first switch circuit connects the N-DAC and the first input amplifier, and connects the P-DAC and the second input amplifier; the second switch circuit connects the second input amplifier and the first output amplifier, and connects the first input amplifier and the second output amplifier, and the third switch circuit connects the second output amplifier and the first pixel electrode, and connects the first output amplifier and the second pixel electrode.

7. The driving circuit of an LCD display of claim 1, wherein both the first input amplifier and the second input amplifier include an operational amplifier.

8. The driving circuit of an LCD display of claim 1, wherein both the first output amplifier and the second output amplifier include an operational amplifier.

9. The driving circuit of an LCD display of claim 1, wherein both the first output amplifier and the second output amplifier include a capacitor coupled in parallel.
